(19) United States
(12) Patent Application Publication
(10) Pub. No.: US 2006/0240730 A1
(43) Pub. Date: Oct. 26, 2006

(54) Wash durable anti-static treatment for textiles and textiles so treated

(76) Inventors: Roy Phillip DeMott, Spartanburg, SC (US); Michael E. Meadows, Lyman, SC (US)

Correspondence Address: Milliken & Company;Legal Department, M-495, 920 Milliken Road, PO Box 1926, Spartanburg, SC, 29304, US

(21) Appl. No.: 11/114,888

(22) Filed: Apr. 26, 2005

(51) Int. Cl. B32B 5/02; B32B 3/00

(52) U.S. Cl. 442/101; 442/59

(57) ABSTRACT

The present disclosure relates to a chemical finish for textiles and, more specifically, to a finish that imparts durable static-dissipating properties to a target substrate. The anti-static finish comprises a polyamine resin and an isocyanate cross-linking compound that create a wash-durable finish suitable for apparel and other textile applications when combined (e.g., during heat-setting). This finish is especially well suited for fabrics made either partially or entirely of synthetic fibers.

### TECHNICAL FIELD

The present disclosure relates to a chemical finish for textiles and, more specifically, to a finish that imparts durable static-dissipating properties to a target substrate. The anti-static finish comprises a polyamine resin and an isocyanate cross-linking compound that are combined (e.g., during heat-setting) to create a wash-durable finish suitable for apparel and other textile applications. This finish is suitable on fabrics made from synthetic fibers, natural fibers, and blends of synthetic and/or natural fibers.

### BACKGROUND

Both textile manufacturers and consumers have long recognized static build-up on clothing, upholstery, carpeting, and other textile products as a problem. Static results from contact between two dissimilar surfaces and is affected by such factors as the surface being contacted, temperature, and humidity.

Most often, people associate static build-up with electric shocks that are felt when a surface is contacted, as the triboelectric charge “jumps” from the person to the contacted surface. For example, a person might get a shock when he touches a doorknob or light switch after walking across a carpeted floor or when he touches his car door after sliding across his upholstered car seat.

A second problem associated with static electricity is commonly referred to as “static cling.” This term describes the tendency of materials of opposite charge to cling to one another. In the case of textile fabrics, static cling negatively affects the appearance of the fabrics, for instance, when lint, pet hair, or other small particles are attracted to the textile surface. This issue is especially problematic when the textile fabric is dark-colored and the lint or particles are white or similarly light-colored.

Efforts to combat the problem of static build-up (for example, with add-on treatments such as static-dissipating sprays) have been only marginally successful. Another approach is the application of anti-static treatments to yarn to assist in the fabric formation process. However, such topical treatments are removed by subsequent laundering of the finished fabric, thereby eliminating any potential benefit to the users of products made with the fabric.

The automotive industry, in particular, has long been interested in anti-static textile treatments to combat electric shocks associated with static build-up. For instance, automobile manufacturers have sought to incorporate anti-static materials for use as upholstery fabrics. Such upholstery fabrics have used carbon-based fibers or grids to produce static-dissipating properties. The charge is dissipated through the grid and away from the seat occupant (for example). The downside of this approach is that the grid is susceptible to breakage, especially in areas where the fabric experiences large amounts of bending. A second downside, when considering this approach for apparel fabrics, for instance, is that the grid tends to break down as a result of laundering.

Yet another approach, also used in the automotive industry, was to create a static-dissipating textile finish consisting of a polyamine resin. Such anti-static automotive fabrics, although well received by the industry, were not subject to washing, a consideration that explains the fabric's ability to retain its static-dissipating properties over time. Hence, the manufacturer's claims of “durability” were limited to durability to abrasion rather than durability to washing.

Accordingly, it is desirable to create a fabric that possesses static-dissipating properties that are durable, especially after multiple washings. Such fabrics—and the treatment to create them—are the subjects of the present disclosure.

### DETAILED DESCRIPTION

The anti-static finish described herein comprises a mildly cationic polyamine resin and an isocyanate cross-linking compound, which are combined in an aqueous solution with a basic pH (preferably, around 9) and are applied to a textile substrate, where the isocyanate compound binds the polyamine resin to the textile substrate.

One potentially preferred polyamine resin is sold by Cognis under the tradename “NONAX 1166.” This resin has been previously used to reduce static electricity on yarns during processing. However, this resin has not been used successfully heretofore to impart wash-durable static-dissipating properties to fabrics after formation. As has been previously discussed, “NONAX 1166” tends to wash out of the fabric with the first laundering, thereby ending its anti-static properties.

The term “isocyanate cross-linking compounds” is intended to encompass capped isocyanate compounds including isocyanate moieties, preferably those which are capped with certain groups, such as esters, ketones, ethers, carboxylic acids (which thus encompasses urethanes), and the like. Since isocyanate moieties are highly reactive when uncapped, it is preferable that such compounds are capped when combined with the polyamine resin. Thus, upon exposure to temperature and time (e.g., as during heat-setting of the treated fabric), the cap (block) groups, such as esters, carboxylic acids, and the like, are removed (unblocked) from the base compound, leaving the isocyanate moieties free to react with both the polyamine resin and textile component to create the finished textile.

Although any such capped compound possessing isocyanate compounds (which are not available for reaction until such cap groups are removed, typically through the exposure to heat) may be used, preferably the compound is a diisocyanate (i.e., having two potentially reactive isocyanate moieties), and more preferably, the compound is diphenylmethane-bis-4,4′-methyleketootim carbamate, available from Mitsubishi Chemical under the tradename “REPEARL MF.” Another potentially preferred compound is sold by Clariant under the tradename “ARKOPHOB DAN.” Such specific diisocyanate-based compounds unblock at a relatively low temperature, thereby removing the ester groups (carbamates) and permitting cross-linking with the reactive groups of the polyamine resin. Although cross-linking will occur naturally over time, heating the finished fabric at temperatures between 195° F. and 450° F. will reduce the curing time requisite for cross-linking and will ensure that the cross-linking is complete. Such self-cross-linking ultimately provides a textile finish that is impervious to deleterious moisture, solvents, and the like, such that washing and/or dry cleaning will not result in significant removal of the finish from the textile.

Another potentially preferred compound to be included in the anti-static composition is a soft acrylic polymer, such as is sold by Rohm & Haas under the tradename “RHOPLEX K-3.” This polymer compound is believed to form a barrier over the fibers to prevent fine-scale fiber breakage, which contributes to static cling. An added benefit is that pilling is also reduced.

The polyamine resin and the isocyanate cross-linking compound are combined in an aqueous solution at a pH in the basic range, preferably, at a pH of between about 8 and about 11, and, most preferably, at a pH of about 9. One particularly suitable pH-adjusting agent is Na₂CO₃, although other compounds that accomplish the same purpose may be used, such as NaHCO₃, NaOH, and NH₄OH. When Na₂CO₃ is used to adjust the pH, it is present in an amount of about 0.3% to about 1.0% of the solution to produce the desired pH level. Other compounds may be used in different amounts, so long as the desired pH is achieved. It is contemplated that using such other compounds (as listed above) may affect the temperature and/or time needed to achieve the contemplated result of a durable finish that is bound to the target textile substrate.

The polyamine resin is added in the range of about 3% to about 5% of the solution, based on the weight of the textile substrate. The isocyanate cross-linking compound is present in the range of about 0.5% to about 1.5% of the solution, based on the weight of the textile fabric. Optionally, a soft acrylic polymer is included in amount of about 1.5% to about 3.0% of the solution, based on the weight of the fabric.

The composition described above is applied to a textile substrate by any of a number of application methods, including, but not limited to, padding, padding and steaming, spraying, foaming (with a foaming agent), exhausting, washing and autoclaving (e.g., as is commonly done with finished garments), and printing, with padding being most preferred. Preferably, the composition is applied to the substrate after dyeing, although it could be applied before dyeing, during dyeing, or before and after dyeing.

Suitable textile substrates for this composition include woven and knit fabrics, as well as nonwoven fabrics, particularly those that are durable to repeated launderings. Composites including one or more of these fabric types may also be used. It should be understood that, although the present finish imparts wash-durable anti-static properties to a textile substrate, it may also be used to impart these properties to substrates that are not intended or expected to be laundered.

This anti-static finish is well suited for substrates that include synthetic fibers or yarns, either partially (e.g., as in a polyester/cotton blend) or entirely. The finish is suitable for fabrics made from blends of synthetic yarns. It is further contemplated that the anti-static finish described herein would impart the desired characteristics to textile fabrics made entirely of natural fibers or yarns, and may provide even greater results due to a more robust binding mechanism.

The anti-static finish and treated textile fabric will be further described by way of the following Examples (2-10), which are intended to be representative and not limiting of the present disclosure.

### EXAMPLE 1: COMPARATIVE

A 2×2 right-hand twill woven, microdenier fabric, which was dyed black and which had a finished weight of 5.60 oz/yd², was treated with a solution containing only “NONAX 1166” polyamine resin, as provided by the manufacturer. Per the manufacturer's suggestion, a pH adjusting compound and a commercially available wetting agent were also incorporated. The formulation contained 5% NONAX 1166, 0.50% Na₂CO₃ to adjust the pH of the solution, and 0.1% TRYCOL 5999 (wetting agent) with an achieved pH of 8.0, where the percentages are based on the weight of the fabric. The resin solution was either exhausted or padded onto the fabric, as indicated below, following the manufacturer's instructions.

The resulting fabric samples were then tested for static cling, using the “Static Half-Life Test” described in Federal Test Method Standard 101B Method 4046. This test applies a charge to an object and measures the time required for the charge to decay to half of the original voltage once the object has been grounded. In an environment with controlled humidity, the Example fabric is charged to 150 volts, and the decay is measured over a two-minute time limit. A passing result is obtained with a measurement of less than 75 volts after the two-minute time has lapsed. The results are listed either as time (in seconds) to dissipate the 150-volt charge to 75 volts or as volts remaining at the end of the two-minute period. The results are shown below.

STATIC HALF LIFE EVALUATION
Time to dissipate 150 V charge in seconds (s) OR voltage (V)
remaining after 2 minutes

| Sample | Method | Formulation | Wash | Results |
|---|---|---|---|---|
| 1A | Exhaust | 3.0% Nonax 1166 | 0 | 100 V |
| | | 0.3% Na₂CO₃ | 5 | 146 V |
| | | | 10 | 146 V |
| 1B | Pad | Water only | 0 | 149 V |
| | | | 5 | 149 V |
| | | | 10 | 147 V |
| 1C | Pad | 5.0% Nonax 1166 | 0 | 1 second |
| | | 0.5% Na₂CO₃ | 5 | 118 V |
| | | 0.1% Trycol 5953 | 10 | 147 V |

A review of the results shown above indicates that the previously available anti-static treatment was incapable of providing static-dissipating properties to the fabric, especially after the fabric was washed. Accordingly, the need for a wash-durable, anti-static treatment was still unmet.

Various treatment formulations were created, in an effort to address and overcome the issue of wash durability. These formulations are described below.

### Treatment Formulations

The following treatment formulations were used on various fabric samples as will be described herein. The percentages are based on the weight of the total solution with a 65% wet pick-up.

| | Formulation Identification | | | | | |
|---|---|---|---|---|---|---|
| Component | I | II | III | IV | V | VI |
| Polyamine resin | 3.0% | 5.0% | 5.0% | 5.0% | 5.0% | 5.0% |
| (NONAX 1166) | | | | | | |
| Capped diisocyanate | 0.5% | 0.75% | 0.5% | 0.5% | 0.5% | 0.5% |
| (REPEARL MF) | | | | | | |
| pH adjusting compound | 0.3% | 0.5% | 0.5% | 0.5% | 0.5% | 0.5% |
| (Na₂CO₃) | | | | | | |
| Soft acrylic polymer | 0% | 0% | 0% | 1.5% | 3.0% | 2.0% |
| (RHOPLEX K-3) | | | | | | |
| Polyurethane resin | 0% | 0% | 0% | 0% | 0% | 2.0% |
| (WITCOBOND W-293) | | | | | | |

These formulations were applied to a number of different textile substrates, each of which is summarized in the following table and is described in detail as follows.

### Substrate Identification

| | | | | Heat-set |
|---|---|---|---|---|
| | | | | Temp. |
| Sample ID | Yarn Type | Fabric Type | Formulation | (° F.) |
| 2 Control | Polyester; microdenier | Twill woven | Water only | n/a |
| 2A | Polyester; microdenier | Twill woven | I | 330 |
| 2B | Polyester; microdenier | Twill woven | II | 330 |
| 3 Control | Polyester; microdenier | Twill woven | Water only | n/a |
| 3A | Polyester; microdenier | Twill woven | I | 330 |
| 3B | Polyester; microdenier | Twill woven | II | 330 |
| 4 Control | Polyester; microdenier | Twill woven | Water only | n/a |
| 4A | Polyester; microdenier | Twill woven | II | 375 |
| 4B | Polyester; microdenier | Twill woven | II | 325 |
| 5 Control | Polyester | Twill woven | Water only | n/a |
| 5A | Polyester | Twill woven | III | 375 |
| 5B | Polyester | Twill woven | IV | 375 |
| 5C | Polyester | Twill woven | V | 375 |
| 6 Control | Polyester | Plain woven | Water only | n/a |
| 6A | Polyester | Plain woven | III | 360 |
| 6B | Polyester | Plain woven | V | 360 |
| 6C | Polyester | Plain woven | VI | 360 |
| 7 Control | Polyester | Single knit | Water only | n/a |
| 7A | Polyester | Single knit | III | 350 |
| 8 Control | Polyester | Ribbed knit | Water only | n/a |
| 8A | Polyester | Ribbed knit | III | 350 |
| 9 Control | Nomex ® (aramid) | Plain woven | Water only | n/a |
| 9A | Nomex ® (aramid) | Plain woven | III | 350 |
| 10A | Polyester | Twill woven | IV | 375 |
| 10B | Polyester | Twill woven | IV | 375 |

The Example 2 fabric was a 2×2 right-hand twill with a finished weight of 5.60 ounces/yard² and a finished width of 62.50 inches, containing a warp of 1/140/200 polyester yarns and a fill of 1/150/100 polyester yarns. The fabric was woven, dyed a khaki color, and then sanded, before a treatment formulation was applied.

The Example 3 fabric was the same as that used in Example 2, with the only difference being that the Example 3 fabric was dyed brown instead of khaki.

The Example 4 fabric was a 2×2 right-hand twill with a finished weight of 5.40 ounces/yard² and a finished width of 62.50 inches, containing a warp of 1/140/200 polyester yarns and a fill of 1/150/100 polyester yarns. The fabric was woven, dyed black, and then subjected to an anti-pilling treatment as described in U.S. Pat. No. 6,673,119 to Kimbrell, Jr., which is commonly owned and hereby incorporated by reference in its entirety.

The Example 5 fabric was a 2×1 right-hand twill woven with a finished weight of 6.80 ounces/yard² and a finished width of 64.50 inches, containing a warp and fill of 2/150/34 textured polyester yarns.

The Example 6 fabric was a 100% polyester plain weave fabric with a finished weight of 5.50 ounces/yard² and a finished width of 64.50 inches, containing 19.0/1.0 ring spun polyester yarns in both the warp and the fill.

The Example 7 fabric was a 100% polyester, single-knit tuck stitch fabric with a finished weight of 5.29 ounces/yard² and a finished width of 63.00 inches, containing 71% ring spun yarn and 29% filament yarn.

The Example 8 fabric was a 100% polyester ribbed knit fabric with a finished weight of 5.37 ounces/yard and a finished width of 62.00 inches, containing 27.0/1.0 ring spun polyester yarns.

The Example 9 fabric was a 100% solution-dyed Nomex® plain weave fabric having a finished weight of 4.35 ounces/yard² and a finished width of 67.25 inches, containing 40/2 ring spun, solution-dyed Nomex® yarns in the warp and fill.

The Example 10 fabric was a 2×1 right-hand twill woven fabric having a finished weight of 7.75 ounces/yard² and a finished width of 63.50 inches, containing 12.0/1.0 open end spun polyester yarns in both the warp and fill directions.

The Example fabrics (2-10) were prepared as described above, using one of six different treatment formulations (I-VI). “Control” fabrics, treated only with water, were also created of each different fabric. The formulations were applied to the fabrics by padding, which occurred after dyeing. The treated fabrics were then dried at 300° F. and heat-set at a temperature between 325° F. and 375° F., as noted in the table.

The Example fabrics were subjected to AATCC Test Method 115-1973, entitled “Electrostatic Clinging of Fabrics.” The test method is essentially as follows. In an environment with a controlled humidity, the Example fabric is rubbed ten times with a piece of wool cloth to create a static charge. The static charge causes the Example fabric to cling to a metal stand. The test measures the amount of time for the Example fabric to release and separate from the stand.

Obviously, for the purposes described herein, shorter release times (which are indicative of greater static dissipation and less static build-up) are desirable. Times of more than two minutes are considered especially poor. The following Table documents the results of the Electrostatic Cling Test of the Example fabrics, as initially created and after a specified number of washings, which were conducted in accordance with the AATCC 130 Wash Method (105° F. with a specified detergent).

ELECTROSTATIC CLING MEASUREMENT
Clinging Time (Minutes)

| | # of Washes at 105° F. | | | | | |
|---|---|---|---|---|---|---|
| Sample ID | 0 | 5 | 10 | 15 | 20 | 25 |
| Ex. 2-Control | 2.2 | 5.2 | 6.3 | 10.0 | 10.0 | — |
| Ex. 2A | 0.3 | 0.4 | 0.5 | 0.7 | 1.4 | — |
| Ex. 2B | 0.3 | 0.4 | 0.5 | 0.5 | 0.7 | — |
| Ex. 3-Control | 6.5 | 6.1 | 6.2 | 10.0 | 10.0 | — |
| Ex. 3A | 0.3 | 0.3 | 0.7 | 0.7 | 1.1 | — |
| Ex. 3B | 0.3 | 0.4 | 0.4 | 0.7 | 1.9 | — |
| Ex. 4-Control | 9.5 | 10.0 | 10+ | 10+ | 10+ | — |
| Ex. 4A | 0.3 | 0.7 | 1.1 | 8.9 | 10+ | — |
| Ex. 4B | 0.3 | 0.4 | 0.7 | 6.1 | 9.5 | — |
| Ex. 5-Control | 3.6 | 1.1 | 8.2 | 10.0 | 7.6 | 5.6 |
| Ex. 5A | 0.3 | 0.4 | 0.5 | 0.7 | 0.6 | 0.6 |
| Ex. 5B | 0.4 | 0.7 | 1.8 | 2.9 | 6.0 | 10.0 |
| Ex. 5C | 0.3 | 0.4 | 0.5 | 0.6 | 0.6 | 0.8 |
| Ex. 6-Control | 7.1 | 5.3 | 6.6 | 2.8 | 2.0 | 2.6 |
| Ex. 6A | 0.3 | 0.4 | 0.4 | 0.4 | 0.4 | 0.4 |
| Ex. 6B | 0.3 | 0.4 | 0.4 | 0.4 | 0.4 | 0.4 |
| Ex. 6C | 0.3 | 0.5 | 0.4 | 0.4 | 0.6 | 0.5 |
| Ex. 7-Control | 0.6 | 0.9 | 1.7 | 5.6 | 7.2 | — |
| Ex. 7A | 0.3 | 0.3 | 0.4 | 0.6 | 0.7 | — |
| Ex. 8-Control | 3.7 | 4.7 | 5.2 | 7.8 | 6.4 | — |
| Ex. 8A | 0.3 | 0.3 | 0.6 | 0.6 | 0.9 | — |

In all cases, the treated Example fabrics performed better (e.g., exhibited less static) than their untreated counterparts. In particular, Examples 5A and 6A that were treated with Formulation III performed well.

As has been previously described, another measure of static-dissipating capability is the Static Half-Life Test documented as Federal Test Method Standard 101B Method 4046. The table below documents the results of the Static Half-Life Testing for several of the Example fabrics, as initially created and after a specified number of washings, the washings being conducted in accordance with the AATCC 130 Wash Method (at 105° F. with a specified detergent).

STATIC HALF LIFE EVALUATION
Time to dissipate 150 V charge in seconds (s)
OR voltage (V) remaining after 2 minutes

| | # of Washes at 105° F. | | | | | |
|---|---|---|---|---|---|---|
| Sample ID | 0 | 5 | 10 | 15 | 20 | 25 |
| Ex. 4-Control | 133 V (fail) | 150 V (fail) | 149 V (fail) | — | 150 V (fail) | 150 V (fail) |
| Ex. 4A | 1 s (pass) | 18 s (pass) | 84 s (pass) | — | 129 V (fail) | 145 V (fail) |
| Ex. 4B | 1 s (pass) | 23 s (pass) | 61 s (pass) | — | 125 V(fail) | 127 V (fail) |
| Ex. 6-Control | 114 V (fail) | 141 V (fail) | 140 V (fail) | 140 V (fail) | 148 V (fail) | 148 V (fail) |
| Ex. 6A | 1 s (pass) | 11 s (pass) | 37 s (pass) | 66 s (pass) | 97 V (fail) | 82 s (pass) |
| Ex. 6B | 1 s (pass) | 12 s (pass) | 25 s (pass) | 42 s (pass) | 103 s (pass) | 98 s (pass) |
| Ex. 6C | 1 s (pass) | 15 s (pass) | 23 s (pass) | 48 s (pass) | 100 V (fail) | 103 V (fail) |
| Ex. 8-Control | 135 V (fail) | 147 V (fail) | 147 V (fail) | 147 V (fail) | 145 V (fail) | — |
| Ex. 8A | 1 s (pass) | 25 s (pass) | 77 s (pass) | 94 s (pass) | 94 V (fail) | — |
| Ex. 9-Control | 125 V (fail) | 133 V (fail) | 136 V (fail) | — | — | — |
| Ex. 9A | 1 s (pass) | 28 s (pass) | 52 s (pass) | — | — | — |
| Ex. 10A | 2 s (pass) | 13 s (pass) | 20 s (pass) | — | — | — |

Example 10B, a production sample, was subjected to industrial launderings, using the AATCC 130 Wash Method, with the exception that the washes were performed at a temperature of 150° F. instead of 105° F. (again with the same specified detergent). Example 10B was also evaluated using the Static Half-Life method described previously. The results are provided below.

STATIC HALF LIFE EVALUATION
Time to dissipate 150 V charge in seconds (s)
OR voltage (V) remaining after 2 minutes

| | # of Washes at 150° F. | | | | | | |
|---|---|---|---|---|---|---|---|
| Sample ID | 0 | 10 | 20 | 30 | 40 | 50 | 70 |
| Ex. 10B | 1 s | 3 s | 5 s | 26 s | 17 s | 3 s | 8 s |
| | (pass) | (pass) | (pass) | (pass) | (pass) | (pass) | (pass) |

The Static Half-Life Test results show that all of the Example fabrics tested have durability for static dissipation through 15 washes, with some showing durability through 25 washes (at 105° F.) to durability through 70 washes (at 150° F.). In each case, the treated Example fabrics performed significantly better than the untreated Control fabrics.

Another benefit of the present treatments is the ability of the treated substrate to release soil. The efficacy of the treatment was evaluated by subjecting various Example fabrics to a Corn Oil Soil Release Evaluation, where scores range from 1.0 to 5.0 and where a value of 3.0 is good and values of 3.5 and higher are excellent. The table below documents the results of the Corn Oil Soil Release Test for several of the Example fabrics, as initially created and after a specified number of washings, the washings being conducted in accordance with the AATCC 130 Wash Method (at 105° F. with a specified detergent). The staining method, with corn oil as the staining agent, is also described in AATCC 130.

CORN OIL SOIL RELEASE TEST
3.0 = good; 3.5 or higher = excellent

# of Washes at 105° F.

| Sample ID | 0 | 5 | 10 | 15 | 20 | 25 |
|---|---|---|---|---|---|---|
| Ex. 2-Control | 3.5 | 3.0 | 3.0 | 2.8 | 2.8 | — |
| Ex. 2A | 3.8 | 3.0 | 3.5 | 3.0 | 2.8 | — |
| Ex. 2B | 3.8 | 3.0 | 3.0 | 3.0 | 3.0 | — |
| Ex. 3-Control | 3.5 | 3.0 | 3.0 | 2.8 | 2.5 | — |
| Ex. 3A | 4.0 | 3.0 | 3.0 | 3.0 | 2.8 | — |
| Ex. 3B | 4.0 | 3.0 | 3.0 | 3.3 | 3.0 | — |
| Ex. 5-Control | 4.5 | 4.0 | 4.5 | 4.5 | 4.5 | 4.5 |
| Ex. 5A | 4.5 | 4.0 | 4.5 | 4.5 | 4.5 | 4.5 |
| Ex. 5B | 4.5 | 4.5 | 4.5 | 4.5 | 4.5 | 4.5 |
| Ex. 5C | 4.5 | 4.5 | 4.5 | 4.5 | 4.5 | 4.5 |
| Ex. 6-Control | 3.0 | 3.0 | 3.0 | 2.5 | 3.0 | 3.5 |
| Ex. 6A | 4.0 | 3.5 | 3.5 | 3.5 | 3.5 | 3.5 |
| Ex. 6B | 3.5 | 3.5 | 3.5 | 3.5 | 3.5 | 3.5 |
| Ex. 6C | 3.5 | 3.0 | 3.0 | 3.0 | 3.0 | 3.5 |
| Ex. 7-Control | 3.5 | 3.5 | 3.0 | 3.0 | 3.0 | — |
| Ex. 7A | 3.8 | 4.0 | 3.8 | 4.0 | 4.0 | — |
| Ex. 8-Control | 2.0 | 2.5 | 2.0 | 2.5 | 2.5 | — |
| Ex. 8A | 2.5 | 4.0 | 3.0 | 3.0 | 3.0 | — |
| Ex. 10A | 5.0 | 5.0 | 5.0 | — | 5.0 | — |

The results show that the present anti-static treatments did not adversely affect the ability of the treated fabrics to release soil. In some cases (e.g., Examples 6A and 7A), soil release was improved.

A final consideration in the creation of the present static-dissipating textile is the ability of the treated fabric to transport moisture through its surface. This feature is especially important when the fabric is used to create a garment. In this instance, it is desirable for the garment to allow the passage of sweat through the fabric away from the body for the comfort of the wearer.

Moisture transport is evaluated as the number of seconds needed for a drop of water to be absorbed into the fabric. Lower times are preferred, with times of less than 10 seconds being considered good.

MOISTURE TRANSPORT TEST (seconds)
<10 seconds = Good

# of Washes at 105° F.

| Sample ID | 0 | 5 | 10 | 15 | 20 | 25 |
|---|---|---|---|---|---|---|
| Ex. 5-Control | <1 | <1 | <1 | <1 | <1 | <1 |
| Ex. 5A | <1 | 2 | <1 | <1 | <1 | <1 |
| Ex. 5B | 5 | <1 | <1 | >30 | >30 | >30 |
| Ex. 5C | 9 | <1 | <1 | <1 | 3 | >30 |
| Ex. 6-Control | 5 | <1 | 2 | 2 | 2 | 2 |
| Ex. 6A | 6 | <1 | 2 | 2 | 2 | 2 |
| Ex. 6B | 7 | <1 | 2 | 2 | 2 | 2 |
| Ex. 6C | 5 | <1 | <1 | <1 | <1 | <1 |
| Ex. 8-Control | 7 | 7 | 7 | 5 | 9 | — |
| Ex. 8A | <1 | <1 | <1 | <1 | <1 | — |
| Ex. 10A | <1 | <1 | <1 | — | <1 | — |

The results show that the anti-static treatment, in most cases, did not adversely affect the moisture transport properties of the Example fabrics. They further show that, in most cases, the moisture transport properties did not diminish with repeated washings.

The present anti-static treatment is useful for producing static-dissipating fabrics for a wide variety of applications. Contemplated end uses, which are meant to be representative and by no means limiting, include work shirts, knit shirts, work pants, casual pants, dress slacks (especially those made with microdenier fibers), linings, barrier fabrics, outer garments (especially for use in flame retardant and electrical arc protection), articles made from nonwoven processes, and thermal layer fabrics (e.g., those made with polyester, Nomex®, and blends). In each of these end uses, the feature of wash-durable static dissipation, in combination with soil release and moisture transport, is particularly desirable.

For these reasons, the present anti-static treatment and fabrics so treated represent useful advancements over the prior art.

We claim:

1. A textile substrate treated to possess anti-static properties, said textile substrate having a finish comprising the reaction product of a polyamine resin and an isocyanate cross-linking compound, wherein said isocyanate cross-linking compound cross-links said polyamine resin to said textile substrate.

2. The textile substrate of claim 1, wherein said finish further comprises a soft acrylic polymer.

3. The textile substrate of claim 1, wherein said textile substrate comprises yarns selected from the group consisting of synthetic yarns, natural yarns, and blends of synthetic yarns and natural yarns.

4. The textile substrate of claim 3, wherein said textile substrate comprises natural yarns.

5. The textile substrate of claim 3, wherein said textile substrate comprises synthetic yarns.

6. The textile substrate of claim 5, wherein said textile substrate comprises polyester yarns.

7. The textile substrate of claim 1, wherein said textile substrate is selected from the group consisting of woven fabrics, knit fabrics, and nonwoven fabrics.

8. The textile substrate of claim 7, wherein said textile substrate is a knit fabric.

9. The textile substrate of claim 7, wherein said textile substrate is a woven fabric.

10. The textile substrate of claim 9, wherein said textile substrate, having been washed at least 15 times in accordance with AATCC 130 Wash Method at 105° F., exhibits a clinging time of less than 2.0 minutes, when measured in accordance with MTCC Test Method 115-1973.

11. The textile substrate of claim 9, wherein said textile substrate, when comprised of polyester yarns and when washed at least 15 times in accordance with MTCC 130 Wash Method at 105° F., exhibits a static half-life of less than 75 volts after 120 seconds, when evaluated in accordance with Federal Test Method Standard 101B Method 4046.

12. The textile substrate of claim 9, wherein said textile substrate, when comprised of polyester yarns and when washed at least 20 times in accordance with MTCC 130 Wash Method at 150° F., exhibits a static half-life of less than 75 volts after 120 seconds, when evaluated in accordance with Federal Test Method Standard 101B Method 4046.

13. A method of imparting anti-static properties to a textile substrate, wherein said method comprises: (a) providing a substrate; (b) applying an aqueous solution to said substrate, said solution comprising a polyamine resin and an isocyanate cross-linking compound; and (c) cross-linking said polyamine resin to said substrate via said isocyanate cross-linking compound.

14. The method of claim 13, wherein said substrate comprises yarns selected from the group consisting of synthetic yarns, natural yarns, and blends of synthetic yarns and natural yarns.

15. The method of claim 14, wherein said substrate comprises synthetic yarns.

16. The method of claim 15, wherein said substrate comprises polyester yarns.

17. The method of claim 13, wherein said polyamine resin is present in an amount of between about 3% and 5% of said solution, where percentages are based on the weight of said substrate.

18. The method of claim 13, wherein said isocyanate cross-linking compound is present in an amount of between about 0.5% and 1.5% of said solution, where percentages are based on the weight of said substrate.

19. The method of claim 13, wherein said isocyanate cross-linking compound is a capped diisocyanate.

20. The method of claim 13, wherein step (b) is accomplished by a process selected from the group consisting of padding, padding and steaming, spraying, foaming, exhausting, printing, and washing and autoclaving.

21. The method of claim 13, wherein step (b) is performed after said substrate is dyed.

22. The method of claim 13, wherein step (b) is performed before said substrate is dyed.

23. The method of claim 13, wherein step (b) is performed during the dyeing of said substrate.

24. The method of claim 13, wherein said solution has a pH of between about 8 and about 11.

25. The method of claim 24, wherein said solution has a pH of about 9.

26. The method of claim 24, wherein Na₂CO₃ is used, in an amount of between about 0.3% to about 1.0% of said solution, to modify the pH of said solution.

27. The method of claim 13, wherein said solution further comprises a soft acrylic polymer, said soft acrylic polymer being present in an amount of between about 1.5% and about 3.0% of said solution, where percentages are based on the weight of said substrate.

28. The method of claim 13, wherein step (c) occurs at a temperature between about 195° F. and 450° F.

29. The method of claim 28, wherein step (c) occurs at a temperature between about 325° F. and 375° F.
